(19) United States
(12) Patent Application Publication
(10) Pub. No.: US 2025/0217055 A1
(43) Pub. Date: Jul. 3, 2025

(54) SOLID STATE DRIVE, INFORMATION PROCESSING APPARATUS, AND CONTROL METHOD

(71) Applicant: Lenovo (Singapore) Pte. Ltd., Singapore (SG)

(72) Inventors: Yusuke Taira, Kanagawa (JP); Takashi Sugawara, Kanagawa (JP)

(73) Assignee: Lenovo (Singapore) Pte. Ltd., Singapore (SG)

(21) Appl. No.: 18/936,526

(22) Filed: Nov. 4, 2024

(30) Foreign Application Priority Data
Dec. 28, 2023 (JP) 2023-222985

(51) Int. Cl. G06F 3/06

(52) U.S. Cl. CPC G06F 3/0634; G06F 3/0625; G06F 3/0659; G06F 3/0679

(57) ABSTRACT

A solid state drive is configured to be connected to an information processing apparatus, and has an electrically rewritable nonvolatile memory and a memory controller that accepts a processing command for the nonvolatile memory and performs processing corresponding to the processing command, the memory controller switching between a first processing mode with higher processing power for the nonvolatile memory and a second processing mode with lower processing power than the first processing mode, depending on the value of queue depth indicating the number of the processing commands issued by the information processing apparatus at a time.

### CROSS-REFERENCE TO RELATED APPLICATIONS

This application claims priority to Japanese Patent Application No. 2023-222985 filed on Dec. 28, 2023, the contents of which are hereby incorporated herein by reference in their entirety.

### BACKGROUND OF THE INVENTION

### Field of the Invention

Embodiments of the present disclosure relate to a solid state drive, an information processing apparatus, and a control method.

### Description of the Related Art

In recent years, information processing apparatuses such as personal computers (PCs) equipped with solid state drives (SSDs) have become popular. Among this type of information processing apparatuses, there are known information processing apparatuses each of which uses a peripheral component interconnect-express (PCIe) bus to connect an SSD in order to speed up data transfer (refer to, for example, Japanese Unexamined Patent Application Publication No. 2023-32086).

### SUMMARY OF THE INVENTION

The power consumption of the conventional information processing apparatuses and SSDs as described above tends to increase as the data transfer speed of SSDs increases, regardless of the processing load. Therefore, the operations of conventional information processing apparatuses and SSDs are limited in some cases due to temperature rise.

Embodiments of the present disclosure provide a solid state drive, an information processing apparatus, and a control method that are able to reduce power consumption and to suppress performance degradation caused by temperature rise.

A solid state drive according to the first aspect of the present disclosure, which is able to be connected to an information processing apparatus, includes: an electrically rewritable nonvolatile memory; and a memory controller that accepts a processing command for the nonvolatile memory and performs processing corresponding to the processing command, the memory controller switching between a first processing mode with higher processing power for the nonvolatile memory and a second processing mode with lower processing power than the first processing mode, depending on a value of queue depth (QD) indicating the number of the processing commands issued by the information processing apparatus at a time.

In the solid state drive according to the first aspect of the present disclosure, the solid state drive is able to be connected to the information processing apparatus via a PCIe bus, and the memory controller confirms the buffer storage section in response to a reception of a notification indicating that the processing command is stored in the buffer storage section included in the information processing apparatus, and switches to the first processing mode when the value of QD is greater than or equal to a predetermined threshold and switches to the second processing mode when the value of QD is less than the predetermined threshold.

Furthermore, in the above solid state drive according to the first aspect of the present disclosure, the memory controller selects a mode with a lower transfer rate of the PCIe bus than the first processing mode in the second processing mode, and selects a mode with a higher transfer rate of the PCIe bus than the second processing mode in the first processing mode.

Still further, in the above solid state drive according to the first aspect of the present disclosure, the memory controller may be able to process the processing commands in parallel by a plurality of threads, and may switch to the first processing mode when at least one of the values of QD corresponding to the respective threads stored by the buffer storage section is greater than or equal to the predetermined threshold.

An information processing apparatus according to the second aspect of the present disclosure incorporates the aforementioned solid state drive.

An information processing apparatus according to the third aspect of the present disclosure includes: a solid state drive that includes an electrically rewritable nonvolatile memory and a memory controller that accepts a processing command for the nonvolatile memory and performs processing corresponding to the processing command; and a main control section that issues the processing command, and causes the solid state drive to switch between a first processing mode with higher processing power for the nonvolatile memory and a second processing mode with lower processing power than the first processing mode, depending on a value of QD that indicates the number of processing commands issued at a time.

A control method according to the fourth aspect of the present disclosure is for a solid state drive, which includes an electrically rewritable nonvolatile memory and a memory controller that accepts a processing command for the nonvolatile memory to perform processing corresponding to the processing command and is able to be connected to an information processing apparatus, the method including a processing step in which the memory controller switches between a first processing mode with higher processing power for the nonvolatile memory and a second processing mode with lower processing power than the first processing mode, depending on a value of QD that indicates the number of the processing commands issued by the information processing apparatus at a time.

The above-described aspects of embodiments of the present disclosure can reduce power consumption and suppress performance degradation caused by temperature rise

### BRIEF DESCRIPTION OF THE DRAWINGS

FIG. 1 is a diagram illustrating an example of the main hardware configuration of an information processing apparatus and an SSD according to the present embodiment.

FIG. 2 is a functional block diagram illustrating an example of a functional configuration of the information processing apparatus according to the present embodiment.

FIG. 3 is a diagram illustrating an example of the power state and power consumption of the SSD according to the present embodiment.

FIG. 4 is a diagram illustrating a relationship between a PCIe bus mode and a transfer rate.

FIG. 5 is a diagram illustrating an example of command processing to the SSD in the information processing apparatus according to the present embodiment.

FIG. 6 is a flowchart illustrating an example of mode switching processing of the SSD according to the present embodiment.

FIG. 7 is a flowchart illustrating an example of temperature control processing of the SSD according to the present embodiment.

FIG. 8 is a diagram illustrating advantageous effects of the information processing apparatus and SSD according to the present embodiment.

FIG. 9 is a functional block diagram illustrating a functional configuration of an information processing apparatus according to a variation of the present embodiment.

### DETAILED DESCRIPTION OF THE INVENTION

A solid state drive, an information processing apparatus, and a control method according to one or more embodiments of the present disclosure are described below with reference to appended drawings.

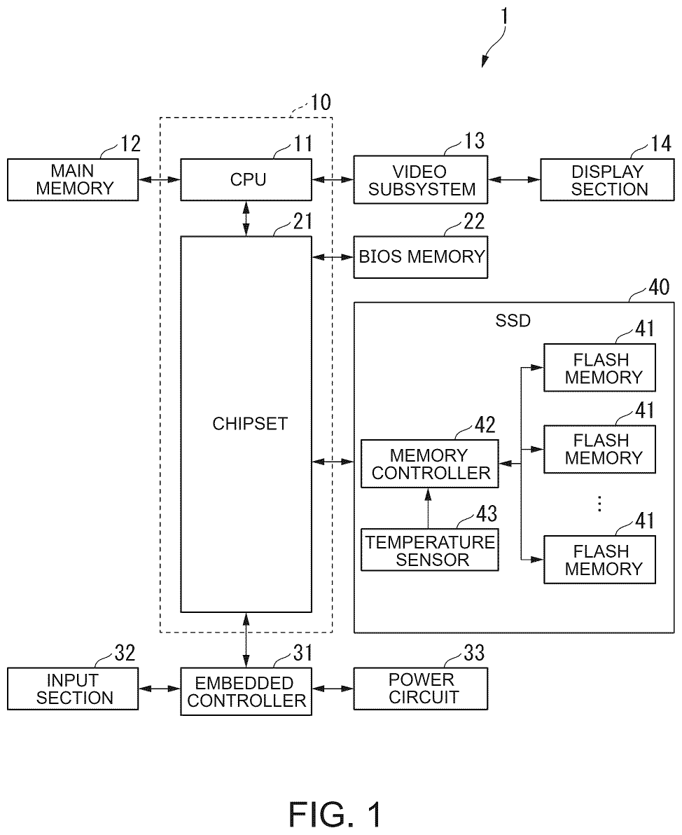

FIG. 1 is a diagram illustrating an example of the main hardware configuration of an information processing apparatus 1 and an SSD 40 according to a first embodiment.

As illustrated in FIG. 1, the information processing apparatus 1 is, for example, a laptop personal computer, including a central processing unit (CPU) 11, a main memory 12, a video subsystem 13, a display section 14, a chipset 21, a basic input output system (BIOS) memory 22, an embedded controller 31, an input section 32, a power circuit 33, and an SSD 40. Note that the information processing apparatus 1 is, for example, a laptop personal computer (laptop PC).

The CPU 11 performs various arithmetic operations under program control to control the entire information processing apparatus 1.

The main memory 12 is a writable memory used as a reading area for execution programs of the CPU 11 or as a working area for writing processing data of the execution programs. The main memory 12 includes, for example, a plurality of dynamic random access memory (DRAM) chips. The execution programs include an operating system (OS), various drivers for hardware operation of peripherals, various services/utilities, application programs, and the like.

The video subsystem 13 is used to implement functions related to image display, and includes a video controller. This video controller processes drawing commands from the CPU 11, writes the processed drawing information into a video memory, reads the drawing information from the video memory, and outputs the drawing information as drawing data (display data) to the display section 14.

The display section 14 is, for example, a liquid crystal display, which displays a display screen based on the drawing data (display data) output from the video subsystem 13.

The chipset 21 has controllers for a universal serial bus (USB), a serial AT attachment (ATA), a serial peripheral interface (SPI) bus, a peripheral component interconnect (PCI) bus, a PCI-Express bus (PCIe), and a low pin count (LPC) bus, to which a plurality of devices is connected. In FIG. 1, the BIOS memory 22 and the SSD 40 are connected to the chipset 21 as examples of devices.

In the present embodiment, the CPU 11 and the chipset 21 correspond to the main control section 10.

The BIOS memory 22 is formed of an electronically rewritable nonvolatile memories such as an electrically erasable programmable read only memory (EEPROM) or a flash ROM (flash memory). The BIOS memory 22 stores a BIOS and system firmware for controlling the embedded controller 31 or the like.

The embedded controller 31 is a one-chip microcomputer that monitors and controls various devices (such as peripheral devices and sensors) regardless of the system status of the information processing apparatus 1. In addition, the embedded controller 31 has a power management function that controls the power circuit 33. The embedded controller 31 is composed of a CPU, a ROM, a RAM, and the like, which are not illustrated, and is equipped with multi-channel A/D input pins, D/A output pins, timers, and digital input/output pins. For example, the input section 32 and the power circuit 33 are connected to the embedded controller 31 via those input/output pins, and the embedded controller 31 controls the operations thereof.

The input section 32 is, for example, an input device such as a keyboard or a pointing device such as a touchpad.

The power circuit 33 includes, for example, a DC/DC converter, a charging/discharging unit, an AC/DC adapter, and the like. The power circuit 33 converts the DC voltage supplied from an external power supply via the AC/DC adapter or from a battery to a plurality of voltages required to operate the information processing apparatus 1. In addition, the power circuit 33 supplies power to each part of the information processing apparatus 1 on the basis of the control from the embedded controller 31.

The solid state drive (SSD) 40 is a memory drive device with a rewritable nonvolatile memory, and stores an OS, various drivers, various services/utilities, application programs, and various data. The information processing apparatus 1 performs various information processing by using the data stored in the SSD 40. The SSD 40 is connected to the chipset 21 via, for example, a serial ATA or a PCIe bus.

In the present embodiment, the SSD 40 is assumed to be connected to the chipset 21 via the PCIe bus.

The SSD 40 includes a plurality of flash memories 41 and a memory controller 42.

The flash memory 41 is, for example, a NAND flash memory. The flash memory 41 has, for example, a floating gate type memory cell, a charge trap type memory cell that stores data by trapping electrons in a charge trap layer without a floating gate, and the like. The memory cell of the flash memory 41 is a multi-bit cell that stores multiple bits of data in a single memory cell, such as, for example, a multiple level cell (MLC), a triple level cell (TLC), and a quad level cell (QLC). Note that the multi-bit cell is a memory cell able to store the equivalent of multiple bits in a single memory cell by setting multiple data write thresholds.

The temperature sensor 43 is a sensor for detecting the temperature inside the SSD 40. The temperature sensor 43 outputs a detected value for the temperature case to the memory controller 42.

The memory controller 42 is a processor including, for example, a CPU, a ROM, a RAM, and the like, which are not illustrated, and controls the SSD 40 comprehensively. The SSD controller 42 performs, for example, control processing of a host interface (host I/F) with the chipset 21, control processing of a memory interface (memory I/F) with the flash memory 41, and data management processing of the flash memory 41.

In addition, the memory controller 42 detects the temperature of the SSD 40 on the basis of the detected value detected by the temperature sensor 43, and controls the detected temperature so as not to exceed a predetermined threshold temperature. The memory controller 42 limits the operation of the SSD 40 and lowers the temperature of the SSD 40, for example, when the detected temperature reaches the predetermined threshold temperature.

The memory controller 42 has a performance mode (first processing mode) with higher processing power and an ecology (ECO) mode (second processing mode) with processing power lower than the higher performance mode, and switches between the performance mode and the ECO mode according to the value of queue depth (QD). The details of the processing of switching the processing mode according to the value of QD are described later.

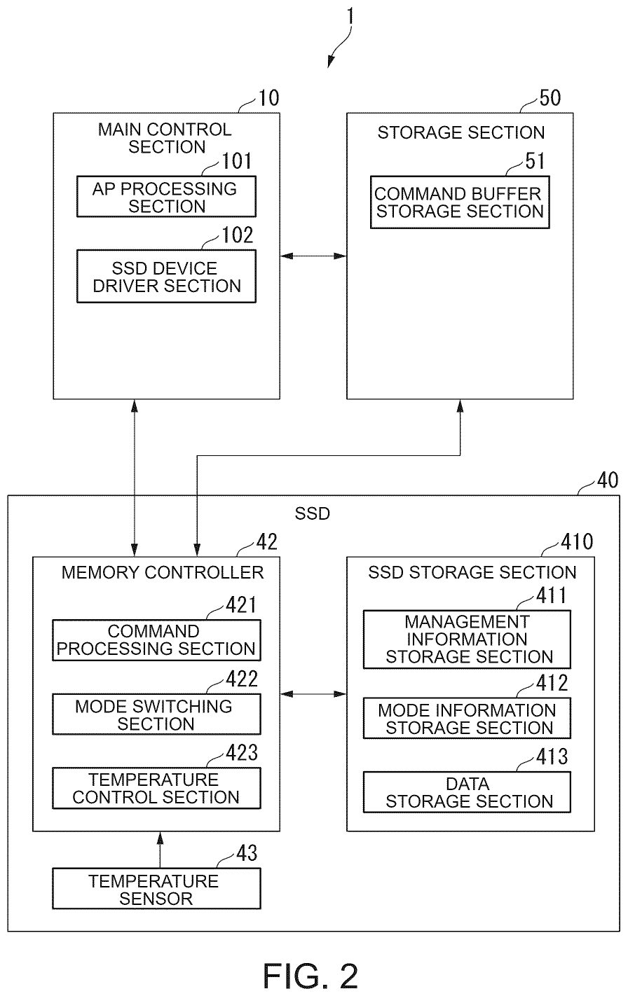

Subsequently, the functional configuration of the information processing apparatus 1 according to the present embodiment is described with reference to FIG. 2.

FIG. 2 is a functional block diagram illustrating an example of the functional configuration of the information processing apparatus 1 according to the present embodiment.

As illustrated in FIG. 2, the information processing apparatus 1 has a main control section 10, an SSD 40, and a storage section 50.

The main control section 10 and the SSD 40 are connected to each other via a PCIe bus.

The storage section 50 is, for example, a storage section implemented by the main memory 12, and stores various information used by the information processing apparatus 1. The storage section 50 includes a command buffer storage section 51.

The command buffer storage section 51 (an example of a buffer storage section) is a storage section implemented by, for example, the main memory 12, and stores a processing command for the SSD 40. The command buffer storage section 51 is able to store a plurality of processing commands, where QD is the number of processing commands issued by the information processing apparatus 1 to the SSD 40 at a time. The command buffer storage section 51 stores the processing commands and data in association with each other. The command buffer storage section 51 stores QD for each of the plurality of threads. The respective threads are processed in parallel by the SSD 40.

The processing commands for the SSD 40 are the commands for performing various processes such as reading data to the SSD 40, writing data, and so on. The processing commands are once stored in the command buffer storage section 51, and then are executed by reading the processing commands into the SSD 40.

The main control section 10 is a functional section implemented by the CPU 11 and the chipset 21 executing the programs stored in the main memory 12, and performs various OS-based processes. The main control section 10, for example, performs various processes based on data stored in the SSD 40. The main control section 10 has an AP processing section 101 and an SSD device driver section 102.

The AP processing section 101 is a functional section that processes application programs executed on the OS. The AP processing section 101, for example, accesses the SSD 40 to read and write data. The AP processing section 101 accesses the SSD 40 via an SSD device driver section 102 described later.

The SSD device driver section 102 is a functional section that implements a device driver used to access the SSD 40. The SSD device driver section 102 stores processing commands in the command buffer storage section 51 according to the access to the SSD 40, and then notifies the SSD 40 that the processing commands are stored in the command buffer storage section 51.

The SSD device driver section 102, for example, acquires read data from the SSD 40 and outputs the read data to the OS or to an application program when the processing command is a read command.

The SSD 40 includes a memory controller 42, a temperature sensor 43, and an SSD storage section 410.

The SSD storage section 410 is, for example, a storage section implemented by the flash memory 41 of the SSD 40, and includes a management information storage section 411, a mode information storage section 412, and a data storage section 413.

The management information storage section 411 is, for example, a storage section implemented by the flash memory 41, and stores management information of the SSD 40. The management information storage section 411 stores, for example, conversion table information between the physical address and the logical address (for example, logical block addressing [LBA] [logical location information]) of the flash memory 41, management information of free and used spaces of the flash memory 41, and so on.

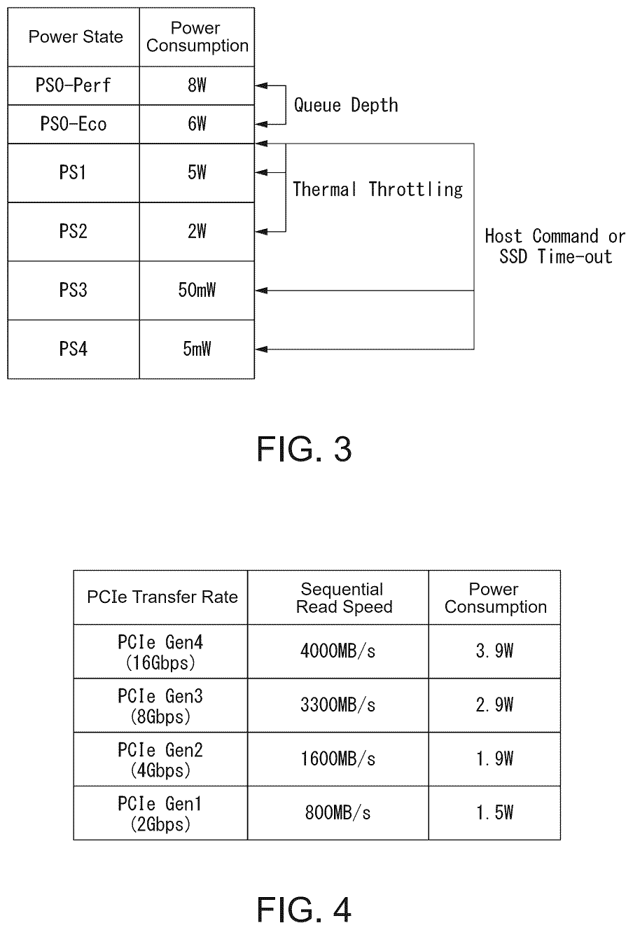

The mode information storage section 412 is, for example, implemented by the flash memory 41 and stores, for example, information indicating processing modes such as the performance mode and the ECO mode, and information indicating a power state. The SSD 40 according to the present embodiment has power states as illustrated in FIG. 3.

FIG. 3 is a diagram illustrating an example of the power state and power consumption of the SSD 40 according to the present embodiment.

As illustrated in FIG. 3, the power state of the SSD 40 includes PS01-Perf, PS0-Eco, PS1, PS2, PS3, and PS4.

PS01-Perf and PS0-Eco are power states that allow normal processing of the SSD 40, where PS01-Perf corresponds to the performance mode and PS0-Eco corresponds to the ECO mode.

PS1 and PS2 indicate states in which some functions of the SSD 40 are limited, and are used for thermal throttling that limits functions so that the temperature does not exceed the predetermined threshold temperature.

PS3 and PS4 indicate standby states, each of which is changed by a processing command from the information processing apparatus 1 or by the timeout of the SSD 40.

Returning again to FIG. 2, the data storage section 413 is a storage section implemented by, for example, the flash memory 41, and stores various data. The data storage section 413 stores, for example, various data of the information processing apparatus 1, the OS and application programs, and the like.

The memory controller 42 includes a command processing section 421, a mode switching section 422, and a temperature control section 423.

The command processing section 421 acquires a processing command from the command buffer storage section 51 in response to a notification from the SSD device driver section 102 of the main control section 10, and performs the processing of the SSD 40 according to the processing command. The command processing section 421 writes data to the SSD storage section 410, reads data from the SSD storage section 410, and performs other processes, according to the processing commands.

The mode switching section 422 switches between the performance mode (first processing mode) with higher processing power for the flash memory 41 and the ECO mode (second processing mode) with lower processing power than the performance mode, depending on the value of QD. Note that QD indicates the number of processing commands of the SSD 40 issued by the information processing apparatus 1 (main control section 10) at a time.

The mode switching section 422 switches to the performance mode, for example, when the value of QD is equal to or greater than a predetermined threshold (for example, two or more). When switching the mode to the performance mode, the mode switching section 422 stores the mode information indicating the performance mode into the mode information storage section 412, and sets the PCIe bus to the highest transfer rate, PCIe Gen4.

Moreover, the mode switching section 422 switches to the ECO mode when, for example, the value of QD is less than the predetermined threshold (for example, less than two). When switching to the ECO mode, the mode switching section 422 stores the mode information indicating the ECO mode in the mode information storage section 412, and sets the PCIe bus to PCIe Gen3, which is lower in transfer rate than the performance mode. The transfer rate of the PCIe bus is described here with reference to FIG. 4.

FIG. 4 is a diagram illustrating a relationship between the PCIe bus mode and the transfer rate.

As illustrated in FIG. 4, there are four generations (Gen) for the PCIe bus, and the higher the number of generations (Gen), the faster the transfer rate is. For example, the maximum transfer rate of PCIe Gen4 is 16 Gbps (gigabits per second), and the sequential read speed of the SSD 40 is 4000 MB/s (megabytes per second).

For example, the maximum transfer rate of PCIe Gen3 is 8 Gbps, and the sequential read speed of the SSD 40 is 3300 MB/s. In addition, for example, the maximum transfer rate of PCIe Gen2 is 4 Gbps, and the sequential read speed of the SSD 40 is 1600 MB/s. Furthermore, for example, the maximum transfer rate of PCIe Gen1 is 2 Gbps, and the sequential read speed of the SSD 40 is 800 MB/s.

In the present embodiment, as an example, the mode switching section 422 uses PCIe Gen4 (16 Gbps) for the performance mode and uses PCIe Gen3 (8 Gbps) for the ECO mode.

Moreover, the mode switching section 422 switches to the performance mode when there is a plurality of threads in the buffer storage section 51, in the case where at least one of the values of QD corresponding to the respective threads is equal to or more than the predetermined threshold (for example, two or more). Furthermore, the mode switching section 422 switches to the ECO mode when there is a plurality of threads in the buffer storage section 51, in the case where the values of QD for all the threads are smaller than the predetermined threshold (for example, smaller than two).

The temperature control section 423 detects the internal temperature of the SSD 40 by using the temperature sensor 43 and controls the SSD 40 so that the detected temperature does not exceed the predetermined threshold temperature. The temperature control section 423 limits the operation of the SSD 40 and lowers the temperature of the SSD 40, for example, when the detected temperature reaches the predetermined threshold temperature. Specifically, the temperature control section 423 changes the power state from PS01-Perf or PS0-Eco to PS1 or PS2 when the predetermined threshold temperature is reached. Note that PS1 or PS2 is a state in which some functions of the SSD 40 are limited such as, for example, a state in which the clock signal is stopped or the frequency is reduced.

Subsequently, the operations of the information processing apparatus 1 and the SSD 40 according to the present embodiment are described with reference to drawings.

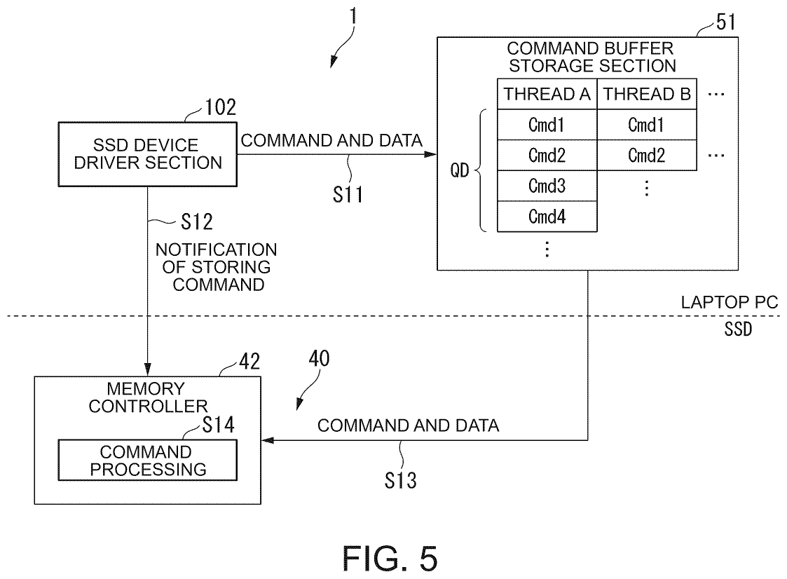

FIG. 5 is a diagram illustrating an example of command processing to the SSD in the information processing apparatus 1 according to the present embodiment.

As illustrated in FIG. 5, when accessing the SSD 40, the SSD device driver section 102 first sends commands and data to the command buffer storage section 51 (step S11). The SSD device driver section 102 expands the processing to the SSD 40 into commands (processing commands), and then stores each command and data (for example, write data, and the like) into the command buffer storage section 51.

Note that a plurality of commands (processing commands) is able to be executed as QDs at a time. In the example illustrated in FIG. 5, thread A stores four processing commands (the value of QD is “4”), and thread B stores two processing commands (the value of QD is “2”).

Then, the SSD device driver section 102 notifies the memory controller 42 of the SSD 40 to store the commands (step S12). The SSD device driver section 102 notifies the memory controller 42 that the processing commands have been stored in the command buffer storage section 51 (command notification).

Next, the memory controller 42 acquires the commands and data from the command buffer storage section 51 (step S13). The command processing section 421 of the memory controller 42 acquires the processing commands and data from the command buffer storage section 51 in response to the notification.

Subsequently, the memory controller 42 performs command processing (step S14). The command processing section 421 performs the command processing according to the processing command acquired from the command buffer storage section 51.

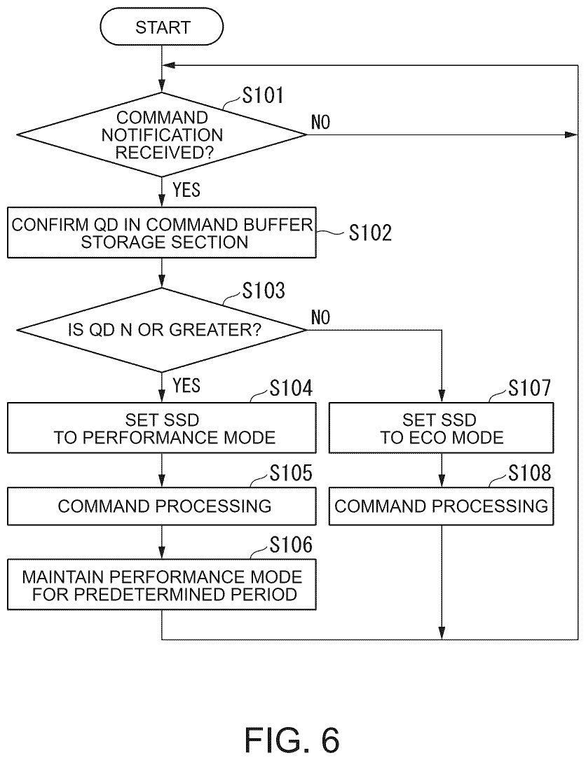

Then, the mode switching processing of the SSD 40 is described with reference to FIG. 6.

FIG. 6 is a flowchart illustrating an example of the mode switching processing of the SSC 40 according to the present embodiment.

As illustrated in FIG. 6, the memory controller 42 of the SSD 40 first determines whether a command notification has been received (step S101). The mode switching section 422 of the memory controller 42 determines whether having received the command notification illustrated in step S12 of FIG. 5 described above. In the case of having received the command notification (step S101: YES), the mode switching section 422 proceeds to step S102. In the case of not having received the command notification (step S101: NO), the mode switching section 422 returns the process to step S101.

In step S102, the mode switching section 422 confirms QD in the command buffer storage section 51.

Then, the mode switching section 422 determines whether QD is greater than or equal to N (step S103), where N is a predetermined threshold such as, for example, “2.” In the case where QD is greater than or equal to N (for example, the value of QD is two or more) (step S103: YES), the mode switching section 422 proceeds to step S104. In the case where QD is less than N (for example, the value of QD is less than two) (step S103: NO), the mode switching section 422 proceeds to step S107.

In step S104, the mode switching section 422 sets the SSD 40 to the performance mode. The mode switching section 422 stores mode information indicating the performance mode in the mode information storage section 412 and sets the PCIe bus to PCIe Gen4 with the highest transfer rate.

Then, the command processing section 421 of the memory controller 42 performs command processing (step S105). Specifically, the command processing section 421 performs the command processing in the performance mode (PCIe Gen4).

Subsequently, the memory controller 42 maintains the performance mode for a predetermined period (a certain period of time) (step S106). After the processing of step S106, the memory controller 42 returns the process to step S101.

In step S107, the mode switching section 422 sets the SSD 40 to the ECO mode. The mode switching section 422 stores mode information indicating the ECO mode in the mode information storage section 412 and sets the PCIe bus to PCIe Gen3 with a lower transfer rate than the performance mode.

Subsequently, the command processing section 421 of the memory controller 42 performs command processing (step S108). Specifically, the command processing section 421 performs the command processing in the ECO mode (PCIe Gen3). After the processing of step S108, the memory controller 42 returns the process to step S101.

The following describes temperature control processing of the SSD 40 according to the present embodiment.

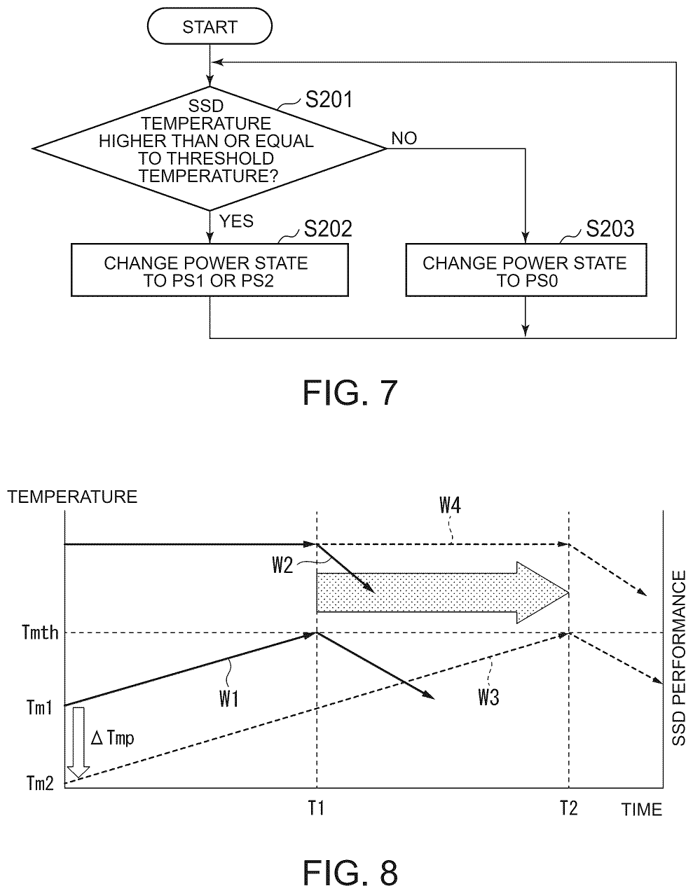

FIG. 7 is a flowchart illustrating an example of the temperature control processing of the SSD 40 according to the present embodiment.

As illustrated in FIG. 7, the memory controller 42 of the SSD 40 first determines whether the temperature of the SSD 40 is higher than or equal to the threshold temperature (step S201). The temperature control section 423 of the memory controller 42 detects the internal temperature of the SSD 40 by using the temperature sensor 43, and determines whether the detected temperature is higher than or equal to the threshold temperature. In the case where the detected temperature is higher than or equal to the threshold temperature (step S201: YES), the temperature control section 423 proceeds to step S202. In the case where the detected temperature is below the threshold temperature (step S201: NO), the temperature control section 423 proceeds to step S203.

In step S202, the temperature control section 423 changes the power state to PS1 or PS2. The temperature control section 423 stores mode information indicating PS1 or PS2 in the mode information storage section 412 and limits a part of the operation. After the processing in step S202, the temperature control section 423 returns the process to step S201.

In addition, in step S203, the temperature control section 423 changes the power state to PS0 (PS01-Perf or PS0-Eco). The temperature control section 423 stores mode information indicating PS0 (performance mode or ECO mode) in the mode information storage section 412 and removes the limits on the operation. After the processing of step S203, the temperature control section 423 returns the process to step S201.

Subsequently, the advantageous effects of the information processing apparatus 1 and the SSD 40 according to the present embodiment are described with reference to FIG. 8.

In FIG. 8, the horizontal axis of the graph represents time, and the vertical axis thereof represents the temperature and performance of the SSD 40.

A waveform W1 in FIG. 8 represents the temperature change in a conventional SSD. A waveform W2 represents the performance of the conventional SSD. A waveform W3 represents the temperature change in the SSD 40 according to the present embodiment. A waveform W4 represents the performance of the SSD 40 according to the present embodiment.

As represented by the waveform W1, the setting of the PCIe bus is fixed to PCIe Gen4 in the conventional SSD, and the base temperature is Tm1. When the SSD is operated continuously under this condition, the threshold temperature Tmth is reached at time T1, and the power state is changed to, for example, PS2 or PS3. This causes the temperature of the conventional SSD to decrease. As represented by the waveform W2, the performance of the conventional SSD also decreases after time T1.

In contrast, the SSD 40 according to the present embodiment switches between the performance mode and the ECO mode, as represented by the waveform W3, and therefore the base temperature is the temperature Tm2. Specifically, the temperature Tm2 is lower than the temperature Tm1 by ΔTmp. In this case, when the SSD 40 is operated continuously, the threshold temperature Tmth is reached at time T2, which is later than time T1, and the power state is changed to, for example, PS2 or PS3.

In the SSD 40 according to the present embodiment, as represented by the waveform W4, the performance does not decrease at the time of switching between the performance mode and the ECO mode, and therefore the performance decreases after time T2.

Thus, in the SSD 40 according to the present embodiment, the period until the threshold temperature Tmth is reached is able to be extended, and the period of high performance is able to be extended.

As described above, the SSD 40 (solid state drive) according to the present embodiment is an SSD that is able to be connected to the information processing apparatus 1, and includes a flash memory 41 (nonvolatile memory) and a memory controller 42. The flash memory 41 is an electrically rewritable nonvolatile memory. The memory controller 42 accepts a processing command for the flash memory 41 and performs processing corresponding to the processing command. The memory controller 42 switches between the performance mode (first processing mode) with high processing power for the flash memory 41 and the ECO mode (second processing mode) with lower processing power than the performance mode, depending on the value of QD. Note that QD indicates the number of processing commands that information processing apparatus 1 issues at a time.

The SSD 40 according to the present embodiment is able to suppress the temperature rise in the SSD 40 since reduction in the processing power by the ECO mode enables a reduction in power consumption. In other words, the SSD 40 according to the present embodiment is able to reduce power consumption and to suppress performance degradation caused by temperature rise.

In the present embodiment, the SSD 40 is able to be connected to the information processing apparatus 1 via the PCIe bus. The memory controller 42 confirms the command buffer storage section 51 (the buffer storage section) in response to a reception of a notification indicating that a processing command is stored in the command buffer storage section 51 included in the information processing apparatus 1. The SSD 40 switches to the performance mode when the value of QD is greater than or equal to the predetermined threshold (for example, two or more), and switches to the ECO mode when the value of QD is less than the predetermined threshold (for example, two).

Thereby, the SSD 40 according to the present embodiment is able to provide ample margin for processing with a heavy processing load by switching to the performance mode when the value of QD is greater than or equal to the predetermined threshold (for example, two or more). In addition, the SSD 40 according to the present embodiment is able to reduce power consumption by switching to the ECO mode when the value of QD is smaller than the predetermined threshold (for example, two). Thus, the SSD 40 according to the present embodiment is able to reduce the performance degradation while reducing the power consumption.

In the present embodiment, the memory controller 42 selects a mode with a lower transfer rate of the PCIe bus (PCIe Gen3 setting mode) than the performance mode (PCIe Gen4 setting mode) in the ECO mode. In addition, the memory controller 42 selects a mode with a higher transfer rate of the PCIe bus (PCIe Gen4 setting mode) than the ECO mode (PCIe Gen3 setting mode) in the performance mode.

Thereby, the SSD 40 according to the present embodiment is able to easily reduce the power consumption by changing the mode to the ECO mode (PCIe Gen3 setting mode), as illustrated in FIGS. 3 and 4. Moreover, as illustrated in the waveforms W3 and W4 in FIG. 8, the SSD 40 according to the present embodiment is able to maintain high performance since the base temperature (temperature Tm2) is reduced and the period until the threshold temperature is reached is able to be extended due to the reduced power consumption.

In the present embodiment, the memory controller 42 is able to process processing commands in parallel by a plurality of threads, and switches to the performance mode in the case where at least one of the values of QD corresponding to the respective threads stored in the command buffer storage section 51 is greater than or equal to the predetermined threshold.

This allows the SSD 40 according to the present embodiment to reduce power consumption and to suppress performance degradation for the plurality of threads.

Moreover, the information processing apparatus 1 according to the present embodiment incorporates the SSD 40 described above.

Thereby, the information processing apparatus 1 according to the present embodiment has the same advantageous effects as the SSD 40 described above, thus is able to reduce power consumption and to suppress performance degradation caused by temperature rise.

The control method according to the present embodiment is for an SSD 40, which includes an electrically rewritable flash memory 41 and a memory controller 42 that accepts a processing command for the flash memory 41 to perform processing corresponding to the processing command and is able to be connected to the information processing apparatus 1, and the control method includes processing steps. In the processing steps, the memory controller 42 is configured to switch between a performance mode with higher processing power for the flash memory 41 and an ECO mode with lower processing power than the performance mode, depending on the value of QD that indicates the number of processing commands issued by the information processing apparatus 1 at a time.

Thereby, the control method according to the present embodiment provides the same advantageous effects as those of the SSD 40 and the information processing apparatus 1 described above, thereby enabling a reduction in power consumption and suppression of performance degradation caused by temperature rise.

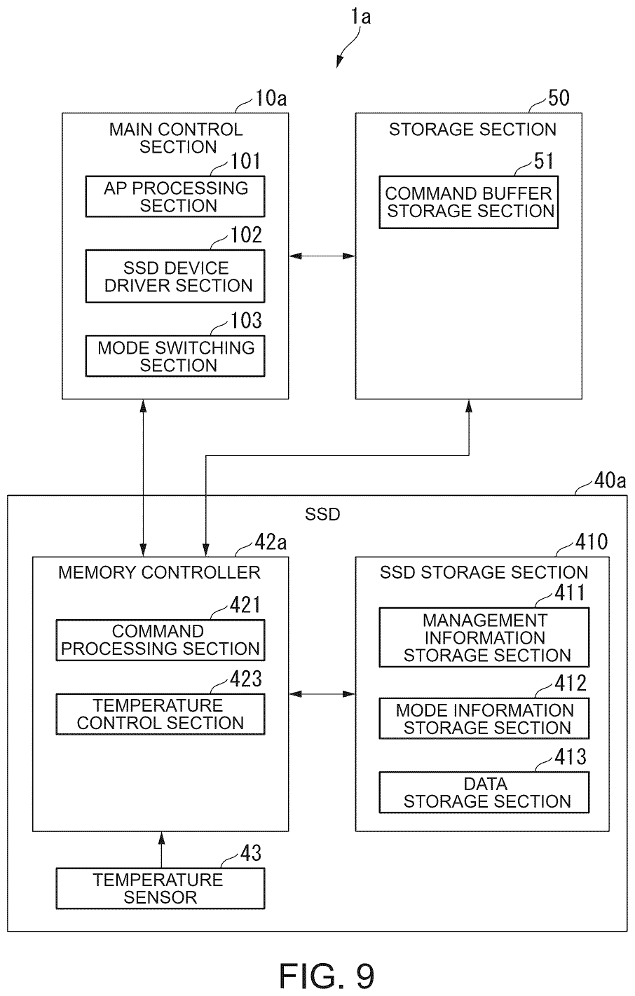

The following describes a variation of the present embodiment with reference to FIG. 9. In the present embodiment described above, description has been made by giving an example that the SSD 40 has the mode switching section 422 to switch between the performance mode and the ECO mode. The main control section 10 of the information processing apparatus 1, however, may also perform the switching. In this section, the variation in which the main control section 10 switches between the performance mode and the ECO mode is described with reference to FIG. 9.

FIG. 9 is a functional block diagram illustrating a functional configuration of an information processing apparatus la according to a variation of the present embodiment.

As illustrated in FIG. 9, the information processing apparatus 1a has a main control section 10a, an SSD 40a, and a storage section 50.

In FIG. 9, the same components as in FIG. 2 described above are given the same reference numerals and description thereof is omitted.

The main control section 10a is a functional section implemented by the CPU 11 and the chipset 21 executing a program stored in the main memory 12, and performs various processes based on the OS. The main control section 10a, for example, executes various processes based on data stored in the SSD 40. The main control section 10a has an AP processing section 101, an SSD device driver section 102, and a mode switching section 103.

The mode switching section 103 switches the SSD 40a between a performance mode (first processing mode) with higher processing power for the SSD 40a and an ECO mode (second processing mode) with lower processing power than the performance mode, depending on the value of QD.

The mode switching section 103 sends a mode switching request to the SSD 40a to switch to the performance mode in the case where, for example, the value of QD is greater than or equal to a predetermined threshold (for example, two or more).

Moreover, the mode switching section 103 sends a mode switching request to the SSD 40a to switch to the ECO mode in the case where, for example, the value of QD is less than the predetermined threshold (for example, less than two).

The SSD 40a has a memory controller 42a and an SSD storage section 410.

The memory controller 42a has a command processing section 421 and a temperature control section 423. When receiving a request to switch to the performance mode from the mode switching section 103, the memory controller 42a stores mode information indicating the performance mode in the mode information storage section 412 and sets the PCIe bus to PCIe Gen4 with the highest transfer rate.

When receiving a request to switch to the ECO mode from the mode switching section 103, the memory controller 42a stores mode information indicating the ECO mode in the mode information storage section 412, and sets the PCIe bus to PCIe Gen3.

As described above, the information processing apparatus 1a according to the variation of the present embodiment includes the SSD 40a and the main control section 10a. The SSD 40a has an electrically rewritable flash memory 41 and a memory controller 42 that accepts a processing command for the flash memory 41 and performs the processing corresponding to the processing command. The main control section 10a is a main control section that issues the processing command, and causes the SSD 40 to switch between the performance mode with higher processing power for the flash memory 41 and the ECO mode with lower processing power than the performance mode, depending on the value of QD that indicates the number of processing commands issued at a time.

This allows the information processing apparatus 1a according to the variation of the present embodiment to achieve the same advantageous effects as the SSD 40 and the information processing apparatus 1 described above, thereby enabling a reduction in power consumption and suppression of performance degradation caused by temperature rise.

Thus, the information processing apparatus 1a may have the main control section 10 that has some or all of the functions of the mode switching section 422 of the SSD 40.

The present disclosure is not limited to the above embodiments, but may be modified to the extent not to depart from the intent of the present disclosure.

For example, in the above embodiments, the information processing apparatus 1 has been described as a laptop personal computer (mobile computer) by giving an example, but is not limited thereto. For example, the information processing apparatus 1 may be a desktop personal computer, a tablet terminal device, or any other information processing apparatus.

Furthermore, in the above embodiments, mode switching has been described by giving an example that the performance mode and the ECO mode with different transfer rates of the PCIe bus are switched, but is not limited thereto. The processing mode may be switched to a mode with limited processing power of the SSD 40 (40a).

Moreover, in the above embodiments, mode switching has been described by giving an example of switching between the PCIe Gen4 setting mode and the PCIe Gen3 setting mode when switching between the performance mode and the ECO mode, but is not limited thereto. For example, the setting mode may be switched between PCIe Gen4 and PCI3 Gen2 or between PCIe Gen3 and PCIe Gen2. In other words, any other combination may be used as long as setting is switched between two transfer rates among the four transfer rates illustrated in FIG. 4 described above.

In the above embodiment, the information processing apparatus 1 (1a) has been described by giving an example of a personal computer-based configuration with an embedded controller 31. The configuration, however, is not limited thereto and the information processing apparatus may be configured without the embedded controller 31. Moreover, the OS of the information processing apparatus 1 is not limited to Windows (registered trademark), but the present disclosure may be applied to other OSs such as, for example, Android (registered trademark) and iOS (registered trademark).

Furthermore, the above embodiments have been described by giving an example that the information processing apparatus 1 (1a) is connected to the SSD 40 (40a) via a PCIe bus. The connection, however, is not limited thereto, and in the case where a new bus faster than the PCIe bus is achieved, the bus other than the PCIe bus may be used.

Each of the above-mentioned information processing apparatus 1 (1a) and SSD 40 (40a) each have a computer system inside in each configuration. A program for implementing the functions of the configuration of the information processing apparatus 1 (1a) and of the SSD 40 (40a) may be recorded in a computer-readable recording medium, and the program recorded in the recording medium may be read and executed by the computer system to perform the processes of the respective configurations of the information processing apparatus 1 (1a) and the SSD 40 (40a) described above. Note that “the program recorded in the recording medium may be read and executed by the computer system” includes installing the program in the computer system. The term “computer system” here includes hardware such as an OS and peripheral devices.

A “computer system” may also include a plurality of computer devices connected via a network including communication lines such as the Internet, WAN, LAN, and dedicated lines. Furthermore, the term “computer readable recording medium” means a portable medium such as a flexible disk, an optical-magnetic disk, a ROM, or a CD-ROM, and a storage device such as a hard disk built in a computer system. Thus, the recording medium storing the program may be a non-transitory recording medium such as a CD-ROM.

A storage medium also includes an internal or external recording medium that is able to be accessed by a delivery server to deliver the program. The program may be divided into a plurality of programs and downloaded at different timings, and then combined in each of the configurations of the information processing apparatus 1 (1a) and the SSD 40 (40a), or the delivery servers that deliver the respective divided programs may be different. Furthermore, the term “computer-readable recording medium” shall also include a recording medium that retains the program for a certain period of time like a computer system's internal volatile memory (RAM) that serves as a server or a client when a program is transmitted via a network. The above program may be used to implement some of the above functions. Moreover, the program may be a so-called difference file (difference program), which is able to implement the above functions by a combination with the program already recorded in the computer system.

In addition, some or all of the above functions may be implemented as an integrated circuit such as a large scale integration (LSI). Each of the above functions may be implemented as a processor individually, or as a processor by integrating some or all of the above functions. The method of implementing the integrated circuit is not limited to the LSI, but may be implemented as a dedicated circuit or a general-purpose processor. In the case where an alternative integrated circuit technology to LSI emerges as a result of progress in the semiconductor technology, an integrated circuit based on the new technology may be used.

### Description of Symbols

1, 1a information processing apparatus
10 main control section
11 CPU
12 main memory
13 video subsystem
14 display section
21 chipset
22 BIOS memory
31 embedded controller (EC)
32 input section
33 power circuit
40, 40a SSD
41 flash memory
42 memory controller
43 temperature sensor
50 storage section
51 command buffer storage section
101 AP processing section
102 SSD device driver section
103, 422 mode switching section
410 SSD storage section
411 management information storage section
412 mode information storage section
413 data storage section
421 command processing section
423 temperature control section

What is claimed is:

1. A solid state drive configured to be connected to an information processing apparatus, comprising:
an electrically rewritable nonvolatile memory; and
a memory controller that accepts a processing command for the nonvolatile memory and performs processing corresponding to the processing command, the memory controller switching between a first processing mode with higher processing power for the nonvolatile memory and a second processing mode with lower processing power than the first processing mode, depending on a value of queue depth (QD) indicating the number of the processing commands issued by the information processing apparatus at a time.

2. The solid state drive according to claim 1, wherein:
the solid state drive is configured to be connected to the information processing apparatus via a peripheral component interconnect-express bus (PCIe); and
the memory controller confirms the buffer storage section in response to a reception of a notification indicating that the processing command is stored in the buffer storage section included in the information processing apparatus, and switches to the first processing mode when the value of queue depth is greater than or equal to a predetermined threshold and switches to the second processing mode when the value of queue depth is less than the predetermined threshold.

3. The solid state drive according to claim 2, wherein the memory controller selects a mode with a lower transfer rate of the PCIe bus than the first processing mode in the second processing mode, and selects a mode with a higher transfer rate of the PCIe bus than the second processing mode in the first processing mode.

4. The solid state drive according to claim 3, wherein the memory controller is configured to process the processing commands in parallel by a plurality of threads, and switches to the first processing mode when at least one of the values of queue depth corresponding to the respective threads stored by the buffer storage section is greater than or equal to the predetermined threshold.

5. An information processing apparatus that incorporates the solid state drive according to claim 4.

6. An information processing apparatus, comprising:
a solid state drive that includes an electrically rewritable nonvolatile memory and a memory controller that accepts a processing command for the nonvolatile memory and performs processing corresponding to the processing command; and
a main control section that issues the processing command, and causes the solid state drive to switch between a first processing mode with higher processing power for the nonvolatile memory and a second processing mode with lower processing power than the first processing mode, depending on a value of queue depth (QD) that indicates the number of processing commands issued at a time.

7. A control method for a solid state drive, which includes an electrically rewritable nonvolatile memory and a memory controller that accepts a processing command for the nonvolatile memory to perform processing corresponding to the processing command and is configured to be connected to an information processing apparatus, the method comprising:
a processing step in which the memory controller switches between a first processing mode with higher processing power for the nonvolatile memory and a second processing mode with lower processing power than the first processing mode, depending on a value of queue depth (QD) that indicates the number of the processing commands issued by the information processing apparatus at a time.
